(19) United States
(12) Patent Application Publication
(10) Pub. No.: US 2022/0018461 A1
(43) Pub. Date: Jan. 20, 2022

(54) SOLENOID VALVE DIAGNOSTIC SYSTEM

(71) Applicant: Ford Global Technologies, LLC, Dearborn, MI (US)

(72) Inventors: Kunal Singh, Farmington Hills, MI (US); Raghuraman Surineedi, Dearborn, MI (US); Venkatesh Krishnan, Canton, MI (US); Ashwin Arunmozhi, Canton, MI (US); Segundo Baldovino, Novi, MI (US); James Alan Acre, Monroe, MI (US)

(73) Assignee: Ford Global Technologies, LLC, Dearborn, MI (US)

(21) Appl. No.: 16/928,168

(22) Filed: Jul. 14, 2020

(51) Int. Cl. F16K 37/00; F16K 31/06; F16K 27/00; G05D 1/00; G05D 1/02

(52) U.S. Cl. CPC F16K 37/0091; F16K 31/0603; G05D 1/0212; F16K 27/003; G05D 1/0061; F16K 37/0066

(57) ABSTRACT

A system can include a solenoid manifold including a plurality of solenoid valves to control fluid flow between a tube and a plurality of nozzles, wherein one end of the tube is connected to a pump and the other end of the tube is connected to an inlet of the solenoid manifold; and a controller programmed to determine whether at least one solenoid valve of the plurality of solenoid valves is incorrectly in an open position based on pressure measurements representing a fluid pressure within the tube.

### BACKGROUND

Vehicles, such as autonomous or semi-autonomous vehicles, typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR or lidar) devices, and image processing sensors such as cameras. A LIDAR device detects distances to objects by emitting laser pulses and measuring the time of flight for the pulse to travel to the object and back. Some sensors are communications devices, for example, vehicle-to-infrastructure (V2I) or vehicle-to-vehicle (V2V) devices. Sensor operation can be affected by obstructions, e.g., dust, snow, insects, etc.

### BRIEF DESCRIPTION OF THE DRAWINGS

FIG. 1 is a diagram of an example vehicle system in accordance with an example implementation of the present disclosure.

FIG. 2 is a diagram illustrating an example fluid apparatus that can clean one or more sensors within the vehicle system.

FIG. 3 is a diagram illustrating an example implementation of the fluid apparatus.

FIG. 4 is a diagram illustrating another example implementation of the fluid apparatus.

FIG. 5 is a diagram illustrating another example implementation of the fluid apparatus.

FIG. 6 is a diagram illustrating another example implementation of the fluid apparatus.

FIG. 7 is a flow diagram illustrating an example method for determining whether at least one solenoid valve within the fluid apparatus is incorrectly stuck in an open position.

### DETAILED DESCRIPTION

A system can include a solenoid manifold including a plurality of solenoid valves to selectively control fluid flow between a tube and a plurality of nozzles, wherein one end of the tube is connected to a pump and the other end of the tube is connected to an inlet of the solenoid manifold; and a controller programmed to determine whether at least one solenoid valve of the plurality of solenoid valves is incorrectly in an open position based on pressure measurements representing a fluid pressure within the tube.

In other features, the system includes at least one sensor that measures the fluid pressure within the tube.

In other features, the at least one sensor comprises a pressure gauge.

In other features, the at least one sensor is mounted to an external surface of the tube.

In other features, the at least one sensor comprises an ultrasonic transducer that generates ultrasonic signals and measures reflected ultrasonic signals.

In other features, the system includes a flowmeter that determines the fluid pressure based on the reflected ultrasonic signals.

In other features, the controller is further programmed to send a signal indicative of the open position, wherein a vehicle alters a vehicle path based on the signal.

In other features, the controller is further programmed to send a signal indicative of the open position, wherein a vehicle transitions from an autonomous mode of operation to a manual mode of operation based on the signal.

In other features, the controller is further programmed to access a lookup table to determine whether the at least one solenoid valve is in the open position based on the pressure measurements.

In other features, the system includes a computer including a processor and a memory, the memory including instructions such that the processor is programmed to receive a signal indicating at least one solenoid valve is in the open position; and actuate at least one vehicle component based on the signal.

A system can include a solenoid manifold including a plurality of solenoid valves arranged to control fluid flow between a tube and a plurality of nozzles, wherein one end of the tube is connected to a pump and the other end of the tube is connected to an inlet of the solenoid manifold; at least one sensor that measures fluid pressure within the tube; and a controller programmed to determine whether at least one solenoid valve of the plurality of solenoid valves is incorrectly in an open position based on pressure measurements representing a fluid pressure within the tube.

In other features, the at least one sensor comprises a pressure gauge.

In other features, the at least one sensor is mounted to an external surface of the tube.

In other features, the at least one sensor comprises an ultrasonic transducer that generates ultrasonic signals and measures reflected ultrasonic signals.

In other features, the system includes a flowmeter that determines the fluid pressure based on the reflected ultrasonic signals.

In other features, the controller is further programmed to send a signal indicative of the open position, wherein a vehicle alters a vehicle path based on the signal.

In other features, the controller is further programmed to send a signal indicative of the open position, wherein a vehicle transitions from an autonomous mode of operation to a manual mode of operation based on the signal.

A system can include a solenoid manifold including a plurality of solenoid valves arranged to control fluid flow between a tube and a plurality of nozzles, wherein one end of the tube is connected to a pump and the other end of the tube is connected to an inlet of the solenoid manifold; an ultrasonic transducer mounted to an external surface of the tube that generates ultrasonic signals and measures reflected ultrasonic signals; and a controller programmed to determine whether at least one solenoid valve of the plurality of solenoid valves is incorrectly in an open position based on the reflected ultrasonic signals representing a fluid pressure within the tube.

In other features, the controller is further programmed to send a signal indicative of the open position, wherein a vehicle alters a vehicle path based on the signal.

In other features, the controller is further programmed to send a signal indicative of the open position, wherein a vehicle transitions from an autonomous mode of operation to a manual mode of operation based on the signal.

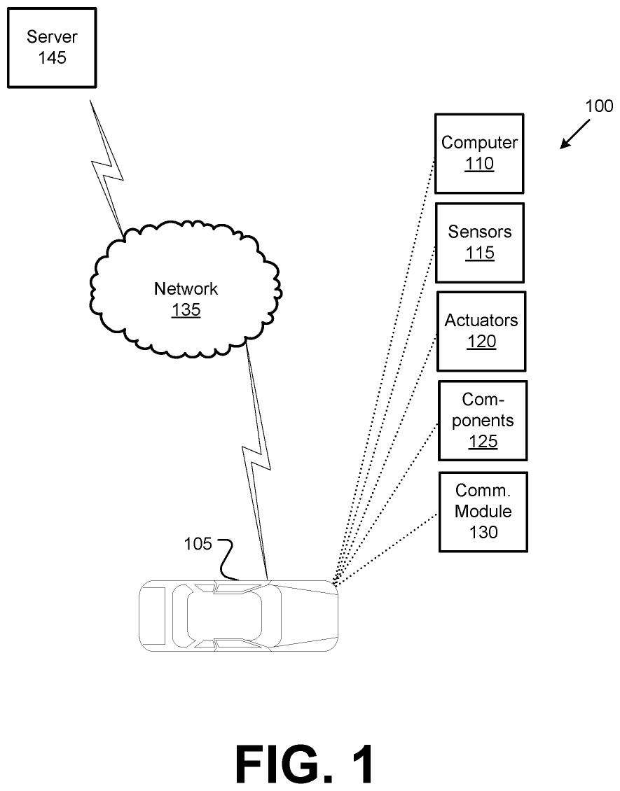

FIG. 1 is a block diagram of an example vehicle system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer-readable media, and stores instructions executable by the computer 110 for performing various operations, including as disclosed herein.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Positioning System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g. front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

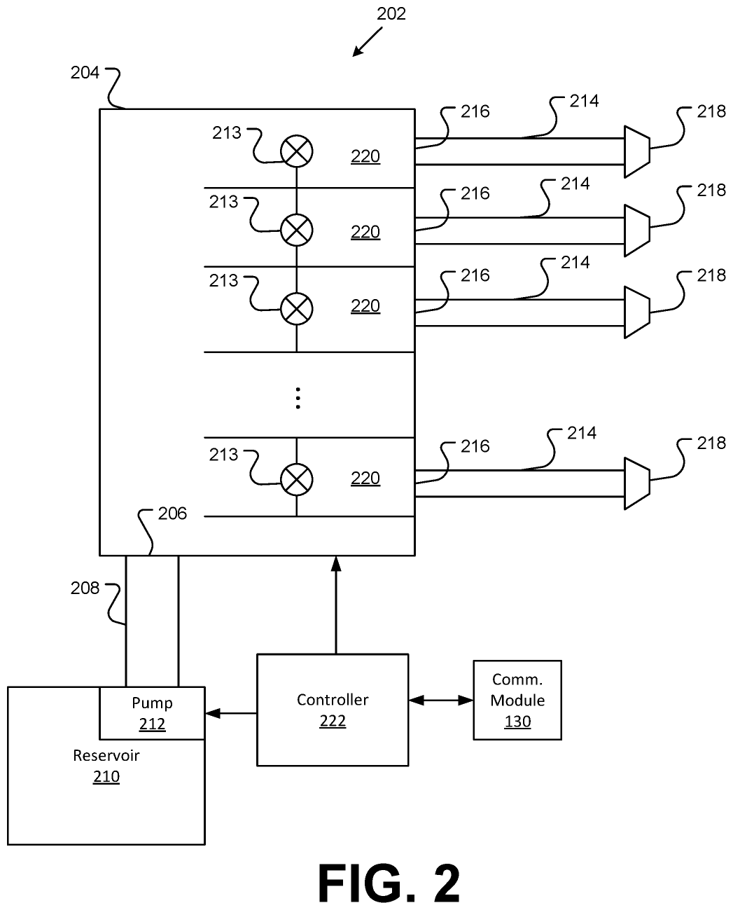

FIG. 2 illustrates an example fluid apparatus 202 for the vehicle 105. The fluid apparatus 202 can disperse pressurized fluid to one or more components of the vehicle 105. In an example implementation, the fluid apparatus 202 provides pressurized fluid to one or more sensors 115 for debris removal and/or cleaning purposes. In some implementations, the computer 110 is programmed to determine whether one or more sensors 115 are at least partially obstructed. For instance, one or more sensors, such as a lidar sensor 115 or a camera sensor 115, may be at least partially obstructed by debris. The computer 110 may use one or more obstruction detection techniques to determine whether at least one sensor 115 is at least partially obstructed. In an example implementation, the computer 110 can be programmed to determine whether a field-of-view of the at least one sensor 115 is reduced. For instance, the computer 110 can determine that the at least one sensor 115 is at least partially obstructed when the field-of-view of the at least one sensor 115 has decreased by a specified (e.g., empirically determined) amount from one time interval to another time interval, and/or has changed from the first to second time interval based on image recognition techniques, etc. As described in greater detail herein, the computer 110 transmits a command to cause the fluid apparatus 202 to disperse pressurized fluid to remove the debris from the sensor 115 based on the determination.

As shown, the fluid apparatus 202 includes a solenoid manifold 204 defining an inlet 206. The inlet 206 is connected to a tube 208 that provides fluid from a reservoir 210 to the solenoid manifold 204. The tube 208 may comprise a hose or a pipe in various implementations. The fluid apparatus 202 can include a pump 212 that displaces the fluid stored in the reservoir 210 to the solenoid manifold 204 via the tube 208.

The fluid apparatus 202 also includes one or more solenoid valves 212 within the solenoid manifold 204. The solenoid valves 212 control the flow of fluid through respective ones of tubes 214. The tubes 214 can be connected to respective outlets 216 defined within the solenoid manifold 204. Respective nozzles 218 are connected to each tube 214 for dispersing the fluid. The reservoir 210, the pump 212, and the nozzles 218 are fluidly connected to each other (i.e., fluid can flow from one to the other) via supply lines 220 within the solenoid manifold 204 and the tube 208.

In an example implementation, the fluid is washer fluid. “Washer fluid” is any liquid stored in the reservoir 210 for cleaning. The washer fluid may include solvents, detergents, diluents such as water, etc.

The reservoir 210 is a tank fillable with liquid, e.g., washer fluid for window and/or sensor 115 cleaning. The reservoir 210 may be disposed in a front of the vehicle 105, specifically, in an engine compartment forward of a passenger cabin. The reservoir 204 may store the washer fluid only for supplying the sensors 115 or also for other purposes, such as supply to a windshield.

The pump 212 can force the washer fluid through the supply lines 220 and the solenoid manifold 204 to the nozzles 218 with sufficient pressure that the washer fluid sprays from the nozzles 218. The pump 212 is fluidly connected to the reservoir 210. The pump 212 may be attached to or disposed in the reservoir 210. The pump 212 is fluidly connected to the solenoid manifold 204, specifically to the inlet 206 via the tube 208.

The solenoid manifold 204 can direct washer fluid entering the inlet 206 to any combination of the outlets 216 by actuating the solenoid valves 212. Each of the nozzles 218 is fluidly connected to one of the outlets 216 via one of the tubes 214. The nozzles 218 are positioned to eject the washing fluid to clear obstructions from the fields of view of the sensors 115, e.g., aimed at the sensors 115 or at windows for the sensors 115. The pressure of the washer fluid exiting the nozzles 218 can dislodge or wash away obstructions that may impede the fields of view of the sensors 115. The solenoid manifold 204 may be constructed from suitable materials, such as a fiber composite structure or the like.

A controller 222 is communicatively coupled to each of the solenoid valves 212, e.g., via a communications bus. The controller 222 is a microprocessor-based computing device, e.g., an electronic controller or the like, a field-programmable gate array (FPGA), an application-specific integrated circuit (ASIC), etc. In an example implementation, the controller 222 may comprise an ECU, a computer such as the computer 110, or the like. That is, the controller 222 can include a processor, a memory, etc., and operations herein ascribed to the controller 222 could be carried out by a computer such as the computer 110 and/or an ECU. The memory of the controller 222 includes media for storing instructions executable by the processor as well as for electronically storing data and/or databases. The controller 222 can be multiple controllers coupled together. As shown, the controller 222 is connected to the communication module 130. In some implementations, the controller 222 may receive commands from the vehicle 105 computer 110 to control one or more of the solenoid valves 212. The controller 222 can also activate and/or deactivate the pump 212 to pressurize the fluid apparatus 202 and/or displace fluid from the reservoir 210 to the solenoid manifold 204.

Each solenoid valve 212 is actuatable between an open position permitting flow and a closed position blocking flow through the respective one of the tubes 214. Each solenoid valve 212 includes a solenoid and a plunger. Electrical current through the solenoid generates a magnetic field, and the plunger moves in response to changes in the magnetic field. Depending on its position, the plunger permits or blocks flow through the respective tubes 214. The controller 222 is programmed to instruct the solenoid valves 212 to actuate. The controller 222 is programmed to instruct each first solenoid valve 212 to actuate independently of other solenoid valves 212.

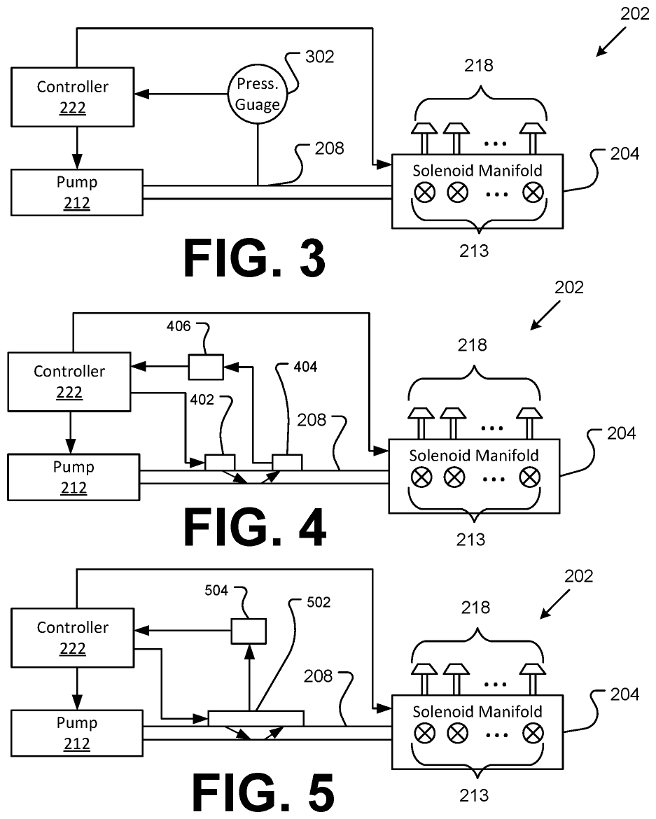

FIGS. 3 through 6 illustrate various example implementations of the fluid apparatus 202. As discussed herein, the controller 222 is programmed to determine whether one or more of the solenoid valves 212 is incorrectly stuck in the open position. A solenoid valve 212 incorrectly stuck in the open position may result in an unintended cleaning of a sensor 115. A solenoid valve 212 may be incorrectly stuck in the open position as a result of a plunger of the solenoid valve 212 not returning to a closed state from an open state after a cleaning operation has concluded.

FIG. 3 illustrates an example fluid apparatus 202 that includes a pressure gauge 302 connected between the pump 212 and the solenoid manifold 204. The pressure gauge 302 can measure the pressure, e.g., fluid pressure, within the tube 208 and provide a signal indicative of the measured pressure to the controller 222. The controller 222 can determine whether one or more of the solenoid valves 212 are incorrectly stuck in the open position based on the measured pressure. For example, the controller 222 can determine a difference in pressure measurements when the pump 212 is activated and when the pump is deactivated. In some implementations, the controller 222 can include a lookup table that relates pressure differences with solenoid valve 212 states, e.g., open position or closed position. In other implementations, the pressure differential may be compared with a predetermined pressure differential threshold. Based on the determination, the controller 222 can determine whether at least one solenoid valve 212 is in the open position incorrectly.

FIG. 4 illustrates another example implementation of the fluid apparatus 202 in which a first sensor 402 and a second sensor 404 are positioned over an external surface of the tube 208. The first sensor 402 may comprise an ultrasonic transducer that generates ultrasonic signals that pass through the tube 208 walls. The flowing liquid within the tube 208 can modify a time difference, a frequency, and/or a phase shift of the generated ultrasonic signals. The second sensor 404 can comprise an ultrasonic sensor that measures ultrasonic signals. The second sensor 404 can convert the measured ultrasonic signals into corresponding electrical signals, and the electrical signals can be provided to a flowmeter 406. The flowmeter 406 receives the electrical signals and determines a flow rate of the fluid within the tube 208. In some implementations, the flowmeter 406 may use ultrasonic transit time techniques to measure the flow rate. For instance, the difference in a transit time between the generated ultrasonic signals and the measured ultrasonic signals is directly proportional to a flow velocity of the fluid and a volume flow rate.

The flowmeter 406 can provide the determined flow rate to the controller 222, and the controller 222 can determine whether at least one solenoid valve 212 is in the open position incorrectly. For instance, the controller 222 may include a lookup table that relates flow rate to solenoid valve states and/or pressure.

FIG. 5 illustrates another example implementation of the fluid apparatus 202 in which a sensor 502 is positioned over an external surface of the tube 208. In this implementation, the sensor 502 may generate and measure ultrasonic signals and provide electrical signals indicative of the measured ultrasonic signals to a flowmeter 504. The sensor 502 can transmit ultrasonic signals into a flow stream of the fluid and measure a frequency shift of the reflected ultrasonic signals. In this implementation, the flowmeter 504 can use ultrasonic doppler techniques to determine a flow rate of the fluid within the tube 208.

The flowmeter 504 can provide the determined flow rate to the controller 222, and the controller 222 can determine whether at least one solenoid valve 212 is in the open position incorrectly. For instance, the controller 222 may include a lookup table that relates flow rate to solenoid valve states.

In one or more implementations, the sensors 402, 404, 502 can be mounted to the external surface of the tube 208 with suitable mounting components. For example, the sensors 402, 404, 502 can be mounted to the tube 208 with a bracket, a clamp, or the like.

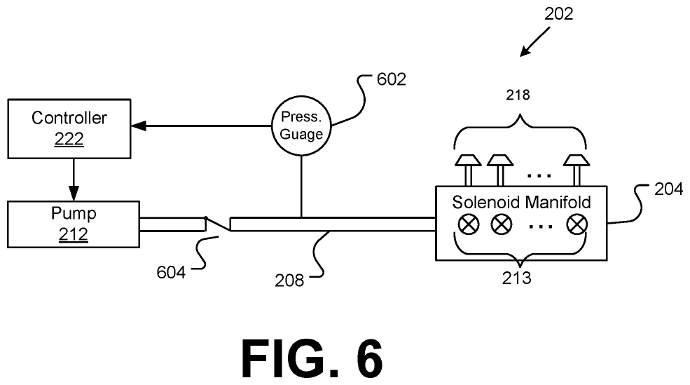

FIG. 6 illustrates another example implementation of the fluid apparatus 202 in which a pressure gauge 602 is positioned between the pump 212 and the solenoid manifold 204. The fluid apparatus 202 also includes a one-way check valve 604 disposed between the pump 212 and the pressure gauge 602. The one-way check valve 604 allows the flow of fluid in one direction and not the other. For instance, the pump 212 can displace the fluid from the reservoir 210 to the solenoid manifold 204 as described above. The one-way check valve 604 prevents the flow of fluid from the solenoid manifold to the pump 212. As such, a measured pressure when the pump 212 is inactive and the solenoid valves 213 are in the closed position is approximately the same pressure as when the pump 212 was active and the solenoid valves 213 are in the closed position. A pressure drop would occur if at least one solenoid valve 212 is incorrectly in the open position.

The pressure gauge 602 can measure pressure within the tube 208 at various time intervals and provide the measured pressure to the controller 222. The controller 222 can compare a difference between measured pressures and determine whether the difference is greater than a predetermined pressure threshold. If the difference is greater than the predetermined pressure threshold, the controller 222 determines that at least one solenoid valve 213 is in an open position.

The controller 222 can be programmed to determine a pressure associated with the fluid apparatus 202 based on one or more of the parameters described above. For example, the controller 222 may include lookup tables that relate one or more of the measured parameters, e.g., flow rate, to pressure. Based on the determined pressure, the controller 222 can determine whether at least one solenoid valve is incorrectly stuck in the open position.

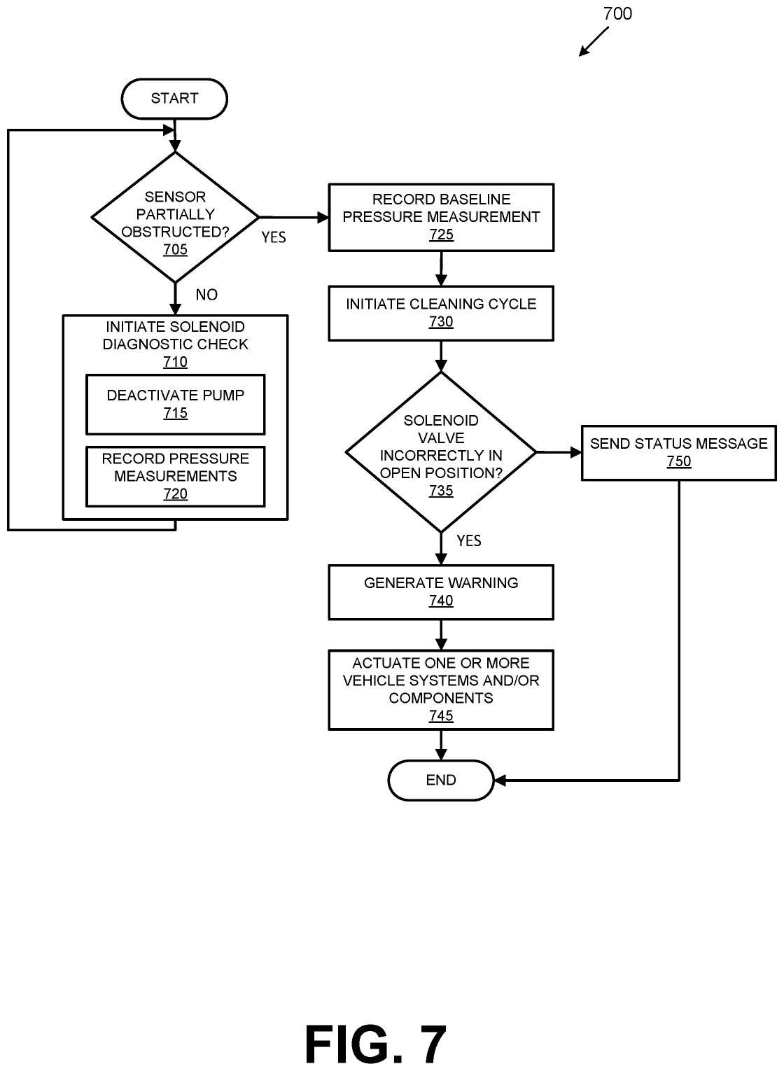

FIG. 7 illustrates an example process 700 for determining whether at least one solenoid valve 213 within the solenoid manifold 204 is incorrectly stuck in an open position. Blocks of the process 700 can be executed by the controller 222 and/or the computer 110.

At block 705, a determination is made whether at least one sensor 115 is at least partially obstructed. As described above, a suitable obstruction detection technique may be used to determine whether at least one sensor 115 is at least partially obstructed. That is, the controller 222 and/or the computer 110 can be programmed to carry out the obstruction detection technique. If there is no at least partial obstruction, a solenoid diagnostic check is initiated at block 710.

As shown, block 710 includes sub-blocks 715 and 720. At block 715, the pump 212 is deactivated. At block 720, one or more pressure measurements are recorded, which is described above in greater detail above. Once recorded, the process 700 returns to block 705.

If there is a partial obstruction, a baseline pressure measurement is recorded at block 725. Once the baseline measurement is recorded, a cleaning cycle, e.g., cleaning event, cleaning protocol, is initiated at block 730. In an example implementation, the controller 222 sends a command to selectively activate one or more solenoid valves 213 to disperse pressurized fluid from the sensor 115. The controller 222 may also send a command to activate the pump 212 to displace fluid from the reservoir 210 to the solenoid manifold 204.

At block 735, a determination is made whether at least one solenoid valve 213 is incorrectly stuck in an open position. In an example implementation, the controller 222 determines the difference between the baseline pressure measurement to the pressure measurements recorded at block 720. In another example implementation, the controller 222 may access a lookup table or the like that stores the pressure measurements recorded at block 720 to determine whether at least one solenoid valve is incorrectly stuck in the open position. If the controller 222 determines that at least one solenoid valve is incorrectly stuck in the open position, a warning is sent to the computer 110 at block 740. The warning may be used by one or more on-board diagnostic (OBD) systems for servicing purposes. At block 745, the computer 110 may actuate one or more vehicle 105 systems based on the warning. For example, the computer 110 may modify a travel path of the vehicle 105, e.g., causing the vehicle 105 to pull-over or to travel to a service facility. In another example, the computer 110 may notify an occupant that the occupant is to take control of the vehicle 105 because the vehicle 105 is transitioning from an autonomous mode to a manual mode of operation.

If the controller 222 determines that each of the solenoid valves 213 are in the closed position, the controller 222 sends a message to the computer 110 indicating the current status of the solenoid valves 213 at block 750. The process 700 then ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising:
a solenoid manifold including a plurality of solenoid valves arranged to control fluid flow between a tube and a plurality of nozzles, wherein one end of the tube is connected to a pump and the other end of the tube is connected to an inlet of the solenoid manifold; and
a controller programmed to determine whether at least one solenoid valve of the plurality of solenoid valves is incorrectly in an open position based on pressure measurements representing a fluid pressure within the tube.

2. The system as recited in claim 1, further comprising at least one sensor that measures the fluid pressure within the tube.

3. The system as recited in claim 2, wherein the at least one sensor comprises a pressure gauge.

4. The system as recited in claim 2, wherein the at least one sensor is mounted to an external surface of the tube.

5. The system as recited in claim 3, wherein the at least one sensor comprises an ultrasonic transducer that generates ultrasonic signals and measures reflected ultrasonic signals.

6. The system as recited in claim 5, further comprising a flowmeter that determines the fluid pressure based on the reflected ultrasonic signals.

7. The system as recited in claim 1, wherein the controller is further programmed to send a signal indicative of the open position, wherein a vehicle alters a vehicle path based on the signal.

8. The system as recited in claim 1, wherein the controller is further programmed to send a signal indicative of the open position, wherein a vehicle transitions from an autonomous mode of operation to a manual mode of operation based on the signal.

9. The system as recited in claim 1, wherein the controller is further programmed to access a lookup table to determine whether the at least one solenoid valve is in the open position based on the pressure measurements.

10. The system as recited in claim 1, further comprising a computer including a processor and a memory, the memory including instructions such that the processor is programmed to receive a signal indicating at least one solenoid valve is in the open position; and actuate at least one vehicle component based on the signal.

11. A system comprising:
a solenoid manifold including a plurality of solenoid valves arranged to control fluid flow between a tube and a plurality of nozzles, wherein one end of the tube is connected to a pump and the other end of the tube is connected to an inlet of the solenoid manifold;
at least one sensor that measures fluid pressure within the tube; and
a controller programmed to determine whether at least one solenoid valve of the plurality of solenoid valves is incorrectly in an open position based on pressure measurements representing a fluid pressure within the tube.

12. The system as recited in claim 11, wherein the at least one sensor comprises a pressure gauge.

13. The system as recited in claim 11, wherein the at least one sensor is mounted to an external surface of the tube.

14. The system as recited in claim 13, wherein the at least one sensor comprises an ultrasonic transducer that generates ultrasonic signals and measures reflected ultrasonic signals.

15. The system as recited in claim 14, further comprising a flowmeter that determines the fluid pressure based on the reflected ultrasonic signals.

16. The system as recited in claim 11, wherein the controller is further programmed to send a signal indicative of the open position, wherein a vehicle alters a vehicle path based on the signal.

17. The system as recited in claim 11, wherein the controller is further programmed to send a signal indicative of the open position, wherein a vehicle transitions from an autonomous mode of operation to a manual mode of operation based on the signal.

18. A system comprising:
a solenoid manifold including a plurality of solenoid valves arranged to control fluid flow between a tube and a plurality of nozzles, wherein one end of the tube is connected to a pump and the other end of the tube is connected to an inlet of the solenoid manifold;
an ultrasonic transducer mounted to an external surface of the tube that generates ultrasonic signals and measures reflected ultrasonic signals; and
a controller programmed to determine whether at least one solenoid valve of the plurality of solenoid valves is incorrectly in an open position based on the reflected ultrasonic signals representing a fluid pressure within the tube.

19. The system as recited in claim 18, wherein the controller is further programmed to send a signal indicative of the open position, wherein a vehicle alters a vehicle path based on the signal.

20. The system as recited in claim 18, wherein the controller is further programmed to send a signal indicative of the open position, wherein a vehicle transitions from an autonomous mode of operation to a manual mode of operation based on the signal.
